(19) United States
(12) Patent Application Publication
(10) Pub. No.: US 2012/0248866 A1
(43) Pub. Date: Oct. 4, 2012

(54) VEHICLE POWER SUPPLY APPARATUS

(75) Inventors: Yoshitomo TAKEUCHI, Chita-gun (JP); Atsuyuki HIRUMA, Kariya-shi (JP); Masakazu TAGO, Aisai-shi (JP)

(73) Assignee: DENSO CORPORATION, Kariya-city (JP)

(21) Appl. No.: 13/432,336

(22) Filed: Mar. 28, 2012

(30) Foreign Application Priority Data
Mar. 30, 2011 (JP) 2011-075564

(51) Int. Cl. B60L 1/00

(52) U.S. Cl. 307/9.1

(57) ABSTRACT

A vehicle power supply apparatus for supplying electrical power from a secondary battery to a prime mover and a plurality of accessories. The apparatus includes a plurality of power converters each electrically connected between a corresponding accessory and the secondary battery and operative to convert electrical power between the secondary battery and the corresponding accessory. The power converters are divided into at least one power-converter group each including at least one power converter electrically connected to a common power supply line connected to the secondary battery. The apparatus further includes at least one power-supply breaker corresponding one-to-one to the at least one group adapted to interrupt power supply from the secondary battery to the corresponding group in response to a command.

### CROSS-REFERENCE TO RELATED APPLICATION

This application is based on and claims the benefit of priority from earlier Japanese Patent Application No. 2011-75564 filed Mar. 30, 2011, the description of which is incorporated herein by reference.

### BACKGROUND

1. Technical Field

This invention relates to a vehicle power supply apparatus for supplying electrical power to a prime mover and a plurality of accessories mounted in a vehicle.

2. Related Art

There are some well-known vehicle power supply apparatuses for supplying electrical power from a secondary battery to a prime mover and a plurality of accessories through their respective power converters. The prime mover may include a vehicle drive motor, a power generation motor, or a drive assist motor that assists in driving a vehicle engine.

As an example, a vehicle power supply apparatus, as disclosed in Japanese Patent Application Publication No. 2006-300038, is adapted to supply electrical power from a secondary battery to an integrated inverter unit incorporating, in a single casing, a power converter for driving an electrical compressor motor and a power converter for driving at least one of motors of the other accessories, such as a water pump, an oil pump, a fan and others, and a vehicle drive motor.

FIG. 4 is a schematic diagram of the disclosed vehicle power supply apparatus. As shown in FIG. 4, the vehicle power supply apparatus 100 includes a power supply breaker 102 that interrupts power supply directly from a secondary battery 101. The power supply breaker 102 connects/disconnects power supply from the secondary battery 101 to a prime mover 103 and a plurality of accessories 104A to 104C. For example, in the presence of an abnormality in one of the accessories 104A to 104C or one of the power converters 106A to 106C connected to the respective accessories 104A to 104C, the power supply breaker 102 interrupts power supply from the secondary battery 101.

In the disclosed vehicle power supply apparatus, since the power converter 107 for driving the prime mover 103 is also connected to the secondary battery 101, the power supply to the prime mover 103 is also interrupted when the power supply from the secondary battery 101 is interrupted by the power supply breaker 102, which may adversely affect a vehicle driving function or the like. Such a problem is likely to occur, particularly in the presence of a large number of accessories 104 supplied with electrical power from the secondary battery 101.

Preferably, power supply to the accessories 104A to 104C and the prime mover 103 is interrupted individually.

In practice, there are various kinds of accessories mounted in a vehicle. Therefore, in the presence of an abnormality in an accessory (also referred here to as a malfunctioning accessory), it is undesirable to deactivate the other accessories as well as the malfunctioning accessory. Preferably, only power supply to the malfunctioning accessory or only power supply to a group of accessories including the malfunctioning accessory is interrupted. In other words, individual power supply interruption or group-based power supply interruption is preferable to a collective power supply interruption where power supply to the prime mover and all the accessories is interrupted simultaneously.

There is known another type of vehicle power supply apparatus such that the secondary battery is a battery pack formed of a plurality of battery cells and a breaker (not shown) breaks an electrical connection between the battery cells to thereby interrupt power supply from the secondary battery. Similarly to the vehicle power supply apparatus 100 as described with reference to FIG. 4, such a vehicle power supply apparatus may also give rise to a similar problem such that, when power supply to a malfunctioning accessory is interrupted, power supply to the other accessories and the prime mover is also interrupted simultaneously by the breaker.

In consideration of the foregoing, exemplary embodiments of the present invention are directed to providing a vehicle power supply apparatus for supplying electrical power to a prime mover and a plurality of accessories mounted in a vehicle, such that in the presence of an abnormality in an accessory, only power supply to a minimum number of accessories including the malfunctioning accessory can be interrupted while power supply to the other accessories and the prime mover is maintained.

### SUMMARY

In accordance with an exemplary embodiment of the present invention, there is provided a vehicle power supply apparatus for supplying electrical power from a secondary battery to a prime mover and a plurality of accessories. The apparatus includes: a first power converter being electrically connected between the secondary battery and the prime mover and being operative to convert electrical power between the secondary battery and the prime mover; and a plurality of second power converters corresponding one-to-one to the plurality of accessories, where each of the second power converters is electrically connected between its corresponding accessory and the secondary battery and is operative to convert electrical power between the secondary battery and the corresponding accessory.

In the above apparatus, the plurality of second power converters are divided into at least one power-converter group, where each power-converter group includes at least one second power converter electrically connected to a common power supply line electrically connected to the secondary battery. The apparatus further includes at least one power-supply breaker corresponding one-to-one to the at least one power-converter group, where each power-supply breaker is provided on the common power supply line and upstream of the corresponding power-converter group to interrupt power supply from the secondary battery to the corresponding power-converter group in response to a command.

With this configuration, power supply to an intended power-converter group is allowed to be interrupted. Accordingly, when there exists an abnormality in an accessory such that power supply to the malfunctioning accessory has to be interrupted, power supply to the intended power-converter group including the power converter corresponding to the malfunctioning accessory can be interrupted by activating the power-supply breaker for the intended power-converter group, which allows power supply to a minimum number of accessories including the malfunctioning accessory to be interrupted with power supply to some other power-converter groups (not including the malfunctioning accessory) and the prime mover being maintained.

### BRIEF DESCRIPTION OF THE DRAWINGS

In the accompanying drawings:

FIG. 1 is a schematic diagram of a vehicle power supply apparatus in accordance with a first embodiment of the present invention;

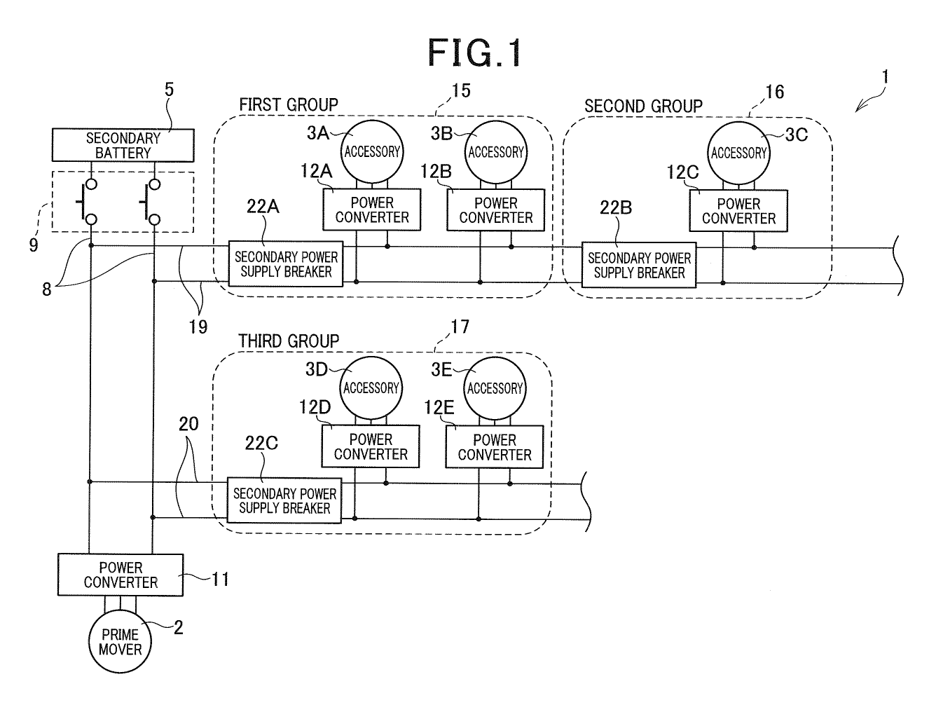

FIG. 2 is a schematic diagram of a vehicle power supply apparatus in accordance with a second embodiment of the present invention;

FIG. 3 is a schematic diagram of the vehicle power supply apparatus in accordance with a modification of the first embodiment; and

FIG. 4 is a schematic diagram of a conventional vehicle power supply apparatus.

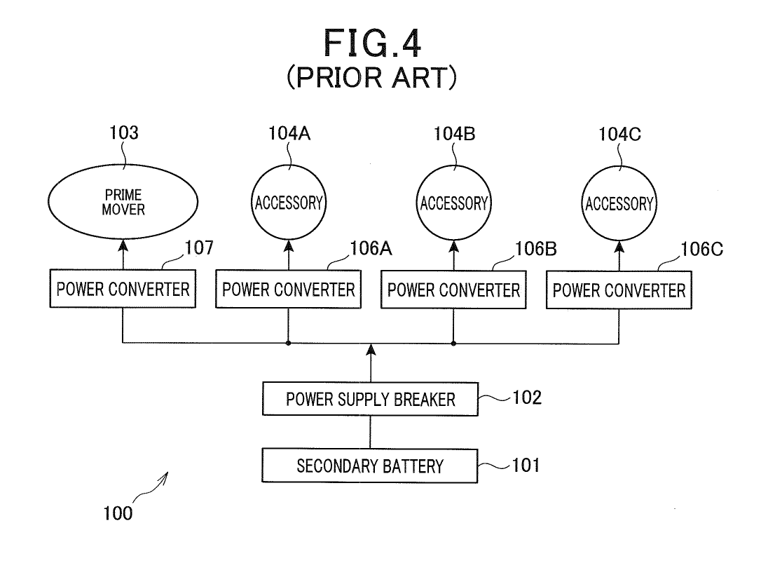

### DESCRIPTION OF SPECIFIC EMBODIMENTS

The present invention will be described more fully hereinafter with reference to the accompanying drawings. Like numbers refer to like elements throughout.

### First Embodiment

There will now be explained a vehicle power supply apparatus 1 in accordance with a first embodiment of the present invention.

(Configuration)

The vehicle power supply apparatus 1 supplies electrical power to a prime mover 2 and a plurality of accessories 3A to 3E from a high-voltage secondary battery 5 that outputs a voltage greater than a lead battery. The vehicle power supply apparatus 1, the prime mover 2, the plurality of accessories 3A to 3E, and the secondary battery 5 are mounted in a vehicle.

The prime mover 2 may include a vehicle drive motor, a power generation motor, a drive assist motor that assists in driving an engine, or the like. For the purpose of illustration, it is assumed in the present embodiment that the prime mover 2 is the vehicle drive motor. The vehicle drive motor 2, which is one of vehicle-mounted electrical loads, is an essential component for driving the vehicle.

Each accessory is a vehicle-mounted electrical load other than the vehicle-mounted prime mover and is responsible for an accessory function other than a vehicle driving function.

More specifically, each accessory may include a water pump that circulates cooling water for cooling the engine, an oil pump for an automatic transmission (AT) hydraulic control system, an electric steering device, a radiator fan, an air-conditioning motor-driven compressor, an air-conditioner blower, an air-conditioner heater, a head lamp, or the like.

The secondary battery 5 is a high-voltage battery that outputs a voltage greater than a voltage of a lead battery, such as a nickel hydride battery and a lithium-ion battery.

The secondary battery 5 is electrically connected to a power supply line 8, which in turn branches into a plurality of power supply lines 8, 19, 20. The vehicle drive motor 2 is electrically connected to one of the power supply lines (power supply line 8) and the others of the power supply lines (power supply lines 19, 20) are each connected to at least one of the plurality of accessories 3A to 3E.

A primary power supply breaker 9 is provide on the power supply line 8 and immediately downstream of the secondary battery 5, so that the primary power supply breaker 9 can interrupt power supply from the secondary battery 5 to the vehicle drive motor 2 and the accessories 3A to 3E. The power supply line 8 is composed of a pair of wirings.

A prime mover dedicated power converter 11 (first power converter) is provided between the secondary battery 5 and the vehicle drive motor 2 to perform power conversion between the secondary battery 5 and the vehicle drive motor 2. Accessory dedicated power converters 12A to 12E (second power converters) are provided between the respective accessories 3A to 3E and the secondary battery 5 to perform power conversion between the respective accessories 3A to 3E and the secondary battery 5. More specifically, the power converter 12A is connected between the accessory 3A and the secondary battery 5 to perform power conversion between the accessory 3A and the secondary battery 5. The power converter 12B is connected between the accessory 3B and the secondary battery 5 to perform power conversion between the accessory 3B and the secondary battery 5, and so on.

Each of the power converters 11, 12A to 12E may be an inverter or a converter. As is well known, the inverter turns on and off a switching element therein to convert a direct-current (DC) power from the secondary battery 5 into an alternating current (AC) current power of a predetermined frequency. The converter turns on and off a switching element therein to convert an alternating current (AC) current power from a corresponding accessory into a direct-current (DC) power of a predetermined voltage.

The plurality of power converters 12A to 12E are divided into at least one power-converter group each including at least one power converter.

For example, in the present embodiment, five power converters 12A to 12E are divided into three power-converter groups (a first group 15, a second group 16, and a third group 17). The first group 15 includes two power converters 12A, 12B, the second group 16 includes one power converter 12C, and the third group 17 includes two power converters 12D, 12E.

In addition, in the present embodiment, the first and second groups 15, 16 are disposed in series, and the third group 17 is disposed in parallel with the first and second groups 15, 16.

The power supply line 8 extending from the secondary battery 5 branches into three power supply lines. A first one of the three power supply lines (power supply line 8) is connected to the power converter 11. A second one of the three power supply lines (power supply line 19) is connected to the first and second groups 15, 16, where the second group 16 is disposed downstream of the first group 15. A third one of the three power supply lines (power supply line 20) is connected to the third group 17.

Each of the first to third power-converter groups 15 to 17 has one or more power converters connected to a common power supply line connected to the secondary battery 5.

More specifically, the power converters 12A, 12B in the first group 15 are connected to the common power supply line 19. The power converter 12C in the second group 16 is connected to the power supply line 19. The power converters 12D, 12E in the third group 17 are connected to the common power supply line 20.

For each of the first to third power-converter groups 15 to 17, a secondary power-supply breaker is provided on one of the power supply lines 19, 20 to interrupt power supply from the secondary battery 5 to the power-converter group.

Each of the secondary power-supply breakers 22A to 22C is a relay or a switch that opens and closes a switch contact to thereby switch between a power-supplied state and a power-interrupted state and is disposed immediately upstream of the most upstream power converter belonging to the corresponding group to interrupt power supply to the group.

In addition, each of the secondary power-supply breakers 22A to 22C interrupts power supply to its corresponding group in response to a power interruption command from a vehicle-mounted electronic control unit (ECU) or the like, which command indicates that there exists an abnormality in at least one of the power converters in the group and the accessories connected the respective power converters.

That is, to interrupt power supply to the first group 15, the secondary power-supply breaker 22A is provided on the power supply line 19 and upstream of the power converter 12A which is disposed upstream of the power converter 12B in the first group 15. The power converters 12A, 12B in the first group 15 are electrically connected to the common power supply line 19.

To interrupt power supply to the second group 16, the secondary power-supply breaker 22B is provided on the power supply line 19 and upstream of the power converter 12C in the second group 16 and downstream of the power converter 12B in the first group 15.

In the present embodiment, since the first group 15 and the second group 16 are electrically connected to the same power supply line 19 in series, power supply to the first group 15 and power supply to the second group 16 are interrupted simultaneously by the secondary power-supply breaker 22A.

To interrupt power supply to the third group 17, the secondary power-supply breaker 22C is provided on the power supply line 20 and upstream of the power converter 12D which is disposed upstream of the power converter 12E in the third group 17.

(Advantages)

In the present embodiment, the plurality of power converters 12A to 12E are divided into one or more power-converter groups (the first to third groups 15 to 17). Each group has one or more power converters connected to a common power supply line connected to the secondary battery 5. For each group, one secondary power-supply breaker is provided on the common power supply line and upstream of the most upstream converter belonging to the group.

This allows power supply to an intended group to be interrupted. More specifically, for example, when there exists an abnormality in an accessory such that power supply to the malfunctioning accessory has to be interrupted, power supply to the intended group including the power converter electrically connected to the malfunctioning accessory may be interrupted by the secondary power-supply breaker in the group. Therefore, only power supply to some accessories including the malfunctioning accessory is interrupted while power supply to the vehicle drive motor 2 and the other accessories is maintained.

For example, when there exists an abnormality in one of the accessories 3D, 3E belonging to the third group 17 such that power supply to the malfunctioning accessory has to be interrupted, the secondary power-supply breaker 22C receives the command indicative of the abnormality. The secondary power-supply breaker 22C interrupts power supply to the third group 17 in response to the command. This allows power supply to the accessories 3D, 3E connected to the respective power converters 12D, 12E in the third group 17 to be interrupted without interruption of power supply to the vehicle drive motor 2 and the first and second groups, which ensures continuation of driving of the vehicle.

In addition, in the present embodiment, the power-converter groups 15 to 17 are connected in series to or in parallel with each other. This leads to a larger degree of freedom of arrangement of the power converters in response to vehicle mountability and dimensions of the respective power converters 12A to 12E.

### Second Embodiment

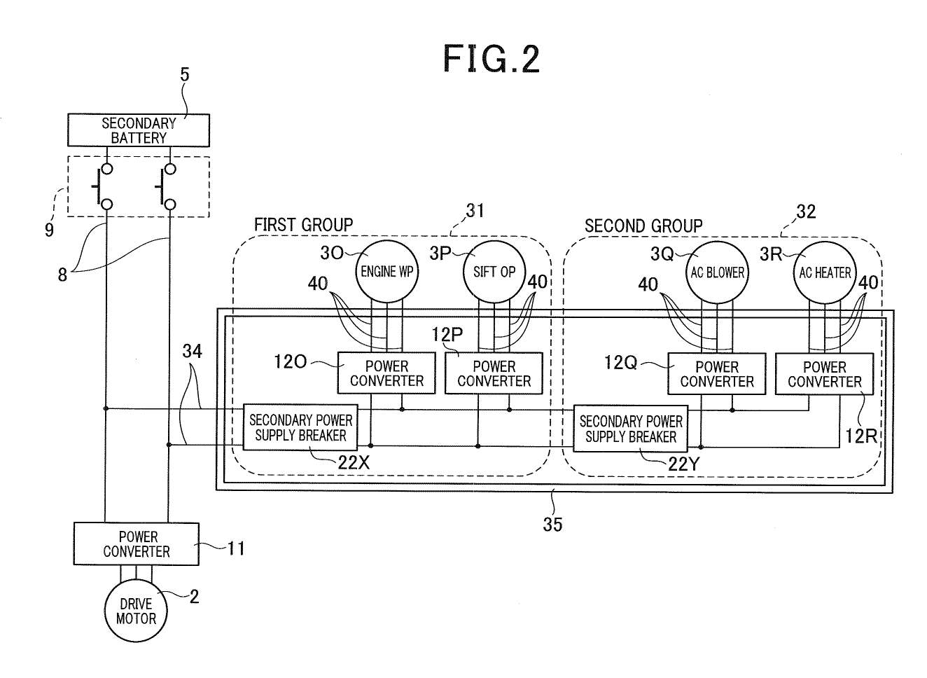

There will now be explained a vehicle power supply apparatus in accordance with a second embodiment with reference to FIG. 2. Only differences of the second embodiment from the first embodiment will be explained.

(Configuration)

In the present embodiment, a plurality of power converters 12O to 12R are divided into one or more distinct power-converter groups according to whether or not each accessory is involved in maintaining a driving function of the vehicle. For example, the plurality of power converters 12O to 12R are divided into two power-converter groups: a power-converter group (first group 31) that is involved in maintaining a driving function of the vehicle and a power-converter group (second group 32) that is not involved in maintaining a driving function of the vehicle.

The accessories 3O, 3P in the first group 31 that are involved in maintaining a driving function of the vehicle may include a water pump that circulates cooling water for cooling the engine, an oil pump for an automatic transmission (AT) hydraulic control system, an electric steering device, a radiator fan, and others. In the present embodiment, it is assumed that the accessory 3O is the water pump and the accessory 3P is the oil pump. The first group 31 further includes a power converter 12O electrically connected to the water pump (e.g., engine WP) 3O and a power converter 12P electrically connected to the oil pump (e.g., shift OP) 3P.

The accessories 3Q, 3R that are not involved in maintaining a driving function of the vehicle may include an air-conditioning motor-driven compressor, an air-conditioner blower, an air-conditioner heater, a head lamp, and others. In the present embodiment, it is assumed that the accessory 3Q is the air-conditioner (AC) blower and the accessory 3R is the air-conditioner (AC) heater. The second group 32 further includes a power converter 12Q electrically connected to the air-conditioner blower 3Q and a power converter 12R electrically connected to the air-conditioner heater 3R.

The first group 31 and the second group 32 are disposed in series, where the first group 31 is electrically connected to the power supply line 34 branched from the power supply line 8 and the second group 32 is electrically connected to the same power supply line 34 and disposed downstream of the first group 31.

In the first group 31, the power converter 12O and the power converter 12P are electrically connected to the power supply line 34, where the power converter 12O is disposed upstream of the power converter 12P. In the second group 32, the power converter 12Q and the power converter 12R are electrically connected to the power supply line 34, where the power converter 12Q is disposed upstream of the power converter 12R.

For each of the first and second power-converter groups 31, 32, a secondary power-supply breaker is provided on the power supply line 34 so that the secondary power-supply breaker can interrupt power supply to the group.

In the first group 31, the secondary power-supply breaker 22X is disposed upstream of the power converter 12O so that the secondary power-supply breaker 22X can interrupt power supply to the first group 31. In the second group 32, the secondary power-supply breaker 22Y is disposed upstream of the power converter 12Q and downstream of the power converter 12P in the first group 31 so that the secondary power-supply breaker 22Y can interrupt power supply to the second group 32.

In addition, in the present embodiment, the first group 31 and the second group 32 are disposed together within a single casing 35, which is made of resin or aluminum alloy or the like.

That is, the power converters 12O to 12R and the secondary power-supply breakers 22X, 22Y are housed together within a single common casing 35.

The water pump 3O, the oil pump 3P, the air-conditioner blower 3Q, and the air-conditioner heater 3R are disposed outside the casing 35.

(Advantages)

The second embodiment exhibits some more advantages than the first embodiment.

In the present embodiment, the plurality of power converters 12O to 12R are divided into the two power-converter groups: the first power-converter group 31 that is involved in maintaining a driving function of the vehicle and the second power-converter group 32 that is not involved in maintaining a driving function of the vehicle, where the first group 31 and the second group 32 are electrically connected to the same power supply line 34 in series and the second group 32 is disposed downstream of the first group 31.

With this configuration, in the presence of an abnormality in the second group 32 that is not involved in maintaining a driving function of the vehicle such that power supply to the accessories and the power converters in the group 32 has to be interrupted, only power supply to the second group is allowed to be interrupted by activating only the secondary power-supply breaker 22Y in the second group 32. In such a case, power supply to the power converters in the first group 31 that is involved in maintaining a driving function of the vehicle and power supply to the vehicle drive motor 2 can be maintained without being interrupted, which can minimize an impact on driving of the vehicle.

On the other hand, in the presence of an abnormality in the first group 31 that is involved in maintaining a driving function of the vehicle such that power supply to the accessories and the power converters in the group 31 has to be interrupted, power supply to the first group 31 and power supply to the second group 32 are allowed to be interrupted simultaneously by activating the secondary power-supply breaker 22X in the first group 31.

In the present embodiment, the first group 31 and the second group 32 are housed together within the single common casing 35, which leads to enhancement of vehicle mountability of the power converters 12O to 12R.

The accessories 3O to 3R (the water pump 3O, the oil pump 3P, the air-conditioner blower 3Q, the air-conditioner heater 3R) electrically connected to the respective power converters 12O to 12R within the casing 35 are disposed outside the casing 35. Since electrical charge accumulates in the power converters 12O to 12R, short power supply lines 40 each connecting one of the accessories 3O to 3R (which are electrical loads for the respective power converters 12O to 12R) and one of the power converters 12O to 12R may cause the electrical charge accumulated in the power converters 12O to 12R to flow or rush into the accessories 3O to 3R, which may adversely affect the accessories 3O to 3R.

The power supply lines 40 can be extended by disposing the power converters 12O to 12R within the casing 35 and disposing the accessories 3O to 3R outside the casing 35 so as to increase interconnect resistances of the respective power supply lines 40. This can prevent the electrical charge accumulated in the power converters 12O to 12R from being supplied to the accessories 3O to 3R. In addition, this leads to a larger degree of freedom of vehicle mountability of the power converters and the accessories.

Switching elements (not shown) in the respective power converters 12O to 12R may be selectively switched to a non-conductive state to interrupt power supply to an accessory having an abnormality. When there exists an abnormality in an accessory such that power supply to the malfunctioning accessory has to be interrupted, power supply to the malfunctioning accessory may be interrupted by switching the switching element in the power converter connected to the malfunctioning accessory to a non-conductive state before activation of the secondary power-supply breaker 22X or 22Y.

Since the electrical charge accumulated in the power converters 12O to 12R may adversely affect the respective accessories 3O to 3R in such an embodiment that the switching elements in the respective power converters 12O to 12R are selectively switched to a non-conductive state, it is desirable to extend the power supply lines 40 as above so as to prevent the electrical charge accumulated in the power converters 12O to 12R from adversely affecting the respective accessories 3O to 3R.

In such an embodiment that the switching elements of the respective power converters 12O to 12R may be selectively switched to a non-conductive state to interrupt the power supply to the malfunctioning accessory before activation of the secondary power-supply breaker 22X or 22Y, whether or not to activate the secondary power-supply breaker 22X or 22Y may be determined on the basis of a condition of the malfunctioning accessory. For example, when there exists an abnormality in a switching element itself in the power converter connected to the malfunctioning accessory, power supply to the power converter having the malfunctioning switching element and the accessory connecting to that power converter can be interrupted by activating the secondary power-supply breaker 22X or 22Y.

This allows power supply to the malfunctioning accessory to be interrupted by switching the switching element in the power converter connected to the malfunctioning accessory to a non-conductive state and, if necessary, activating the secondary power-supply breaker 22X or 22Y, which leads to enhancement of safety of the accessories 3O to 3R.

(Modifications)

There will now be explained some modifications of at least one of the first and second embodiments that may be devised without departing from the spirit and scope of the present invention.

In the first and second embodiments, the prime mover is a vehicle drive motor. Alternatively, the prime mover may be a motor-generator (i.e., an electrical motor having a power generating function) or a generator.

In the first embodiment, the plurality of accessories are divided into three power-converter groups. In the second embodiment, the plurality of accessories are divided into two power-converter groups. More generally, the plurality of accessories may be divided into at least one power-converter group.

In the first and second embodiments, each power-converter group includes up to two power converters. More generally, each power-converter group may include one or more power converters.

In the second embodiment, the two power-converter groups 31, 32 are housed together in the single casing 35. Alternatively, the power-converter groups may be housed in their respective casings, where each casing includes only one power-converter group.

In the first and second embodiments, the primary power supply breaker 9 interrupts power supply to the prime mover 2 and all the accessories equally and simultaneously. Alternatively, the secondary battery 5 may be a battery pack including a plurality of battery cells and a breaker that breaks an electrical connection between the battery cells. Power supply from the secondary battery 5 to the prime mover 2 and all the accessories may be interrupted equally and simultaneously by activating the breaker.

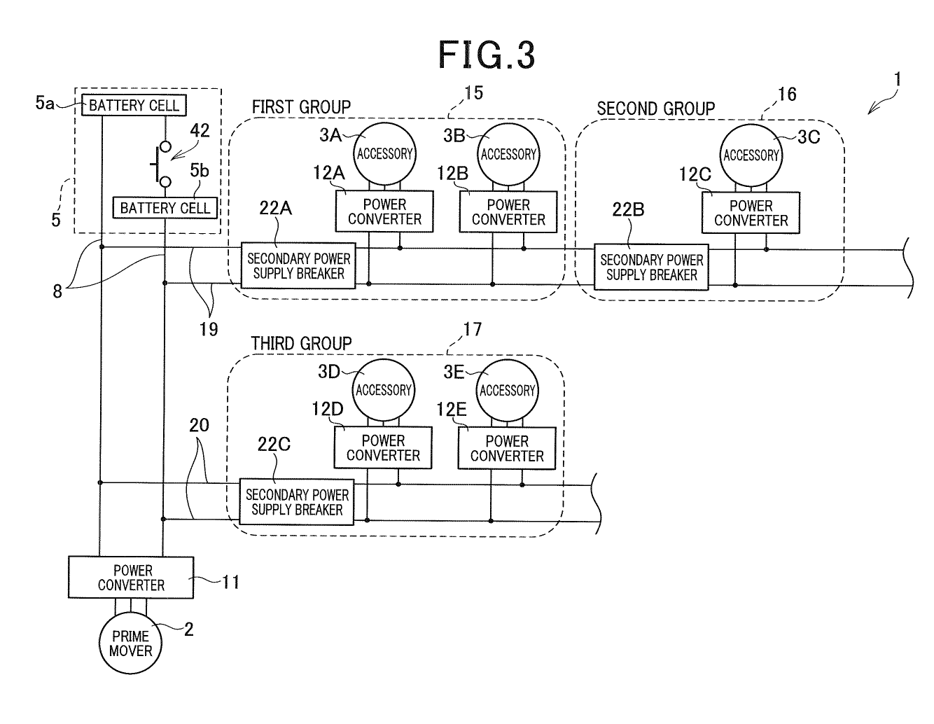

For example, as shown in FIG. 3, the secondary battery (battery pack) 5 includes two battery cells 5a, 5b and a breaker electrically connected between the battery cells 5a, 5b. One of the two wirings of the power supply line 8 is electrically connected to the battery cell 5a and the other is electrically connected to the battery cell 5b. When the breaker 42 breaks an electrical connection between the battery cell 5a and the battery cell 5b, power supply from the secondary battery 5 to the prime mover 2 and all the accessories is interrupted equally and simultaneously. In general, the number of the battery cells is not limited to two.

Alternatively, for example, the secondary battery 5 may be a battery unit including two assembled batteries and a breaker electrically connected between the two assembled batteries to break an electrical connection therebetween. Power supply to the prime mover 2 and all the accessories can be interrupted equally and simultaneously by activating the breaker. Also, in general, the number of the assembled batteries is not limited to two.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A vehicle power supply apparatus for supplying electrical power from a secondary battery to a prime mover and a plurality of accessories, the apparatus comprising:
a first power converter being electrically connected between the secondary battery and the prime mover and being operative to convert electrical power between the secondary battery and the prime mover;
a plurality of second power converters corresponding one-to-one to the plurality of accessories, each of the second power converters being electrically connected between its corresponding accessory and the secondary battery and being operative to convert electrical power between the secondary battery and the corresponding accessory, the plurality of second power converters being divided into at least one power-converter group, each power-converter group including at least one second power converter electrically connected to a common power supply line electrically connected to the secondary battery; and
at least one power-supply breaker corresponding one-to-one to the at least one power-converter group, each power-supply breaker being provided on the common power supply line and upstream of the corresponding power-converter group to interrupt power supply from the secondary battery to the corresponding power-converter group in response to a command.

2. The apparatus of claim 1, further comprising a power-supply breaker provided on a power supply line electrically connected to the secondary battery and upstream of the prime mover and the plurality of accessories, the power-supply breaker being operative to interrupt power supply from the secondary battery to the prime mover and the plurality of accessories simultaneously.

3. The apparatus of claim 1, wherein the secondary battery comprises a first battery cell and a second battery cell and a breaker, the breaker being electrically connected between the first and second battery cells and being operative to break an electrical connection between the first and second battery cells to thereby interrupt power supply from the secondary battery to the prime mover and the plurality of accessories simultaneously.

4. The apparatus of claim 1, wherein
the at least one power-converter group comprises a plurality of power-converter groups, and
the plurality of power-converter groups are electrically connected in series to or in parallel with each other.

5. The apparatus of claim 1, wherein
at least one of the at least one power-converter group is housed together within a single casing.

6. The apparatus of claim 1, wherein the at least one power-converter group is housed individually within a casing.

7. The apparatus of claim 5, wherein at least one accessory corresponding one-to-one to at least one second power converter belonging to the at least one power-converter group within the single casing is disposed outside the casing.

8. The apparatus of claim 1, wherein the at least one power-converter group comprises a first power-converter group and a second power-converter group that is different from the first power-converter group,
each of the plurality of second power converters is allocated to either one of the first and second power-converter groups according to whether or not the accessory electrically connected to the second power converter is involved in maintaining a driving function of the vehicle.

9. The apparatus of claim 8, wherein
the first power-converter group is involved in maintaining a driving function of the vehicle,
the second power-converter group is not involved in maintaining a driving function of the vehicle,
the first power-converter group and the second power-converter group are electrically connected to the common power supply line, and
the second power-converter group is disposed downstream of the first power-converter group.
